(19) United States
(12) Patent Application Publication
(10) Pub. No.: US 2009/0033112 A1
(43) Pub. Date: Feb. 5, 2009

(54) Lifting device suitable for submersibles

(75) Inventors: Lars Westerlind, Motala (SE); Anders Kanskar, Motala (SE); Lars Lundberg, Motala (SE)

Correspondence Address: VENABLE LLP, P.O. BOX 34385, WASHINGTON, DC, 20043-9998, US

(73) Assignee: SAAB AB, Linkoping (SE)

(21) Appl. No.: 12/149,166

(22) Filed: Apr. 28, 2008

(30) Foreign Application Priority Data
Apr. 26, 2007 (EP) 07107030.4

(51) Int. Cl. B66C 1/10

(52) U.S. Cl. 294/82.27

(57) ABSTRACT

A lifting device for connecting a lifting member to an object to be lifted. The device is particularly useful for attaching a lifting member to an unmanned underwater vehicle under open sea conditions. The device includes a first member to be connected to the lifting member and to be lowered together with the same guided by a rope ending at a second member, the second member being attached to the object in advance. The first member defines an opening for the second member such that when the first member is lowered guided by the rope, the second member will, due to the special shape of the two members, enter into the opening of the first member and establish a connection strong enough for lifting the object.

### CROSS-REFERENCE TO RELATED APPLICATIONS

This application claims priority to European patent application 07107030.4 filed 26 Apr. 2007.

### TECHNICAL FIELD OF THE INVENTION

The present invention relates to a lifting device for connecting a lifting wire to a heavy object to be lifted. In particular it relates to the field of lifting underwater vehicles provided with a guiding rope to the entity which is to lift it, e.g., a mother ship.

### BACKGROUND

When handling equipment which is submersed in a liquid, or is floating in surface water, for instance an unmanned underwater vehicle, a normal operation is to lower the vehicle from a mother ship to the water level using a crane. It is also a normal operation to recover the unmanned vehicle after its mission is completed by attaching a lifting member of the crane to the unmanned vehicle and lift it back on board the mother ship. This later operation may be a troublesome and time consuming endeavour. Some efforts to reduce the problem of attaching a lifting member to a heavy submersible object is reflected by cited prior art.

U.S. Pat. No. 3,661,416 discloses a load gripping attachment for lowering a small craft from a mother ship and lifting it back. The attachment comprises a body with a longitudinal axis, and a liner installed in the body for movement along the longitudinal axis. Side ports are provided in the liner and swivelling thrust elements are mounted in the liner and located in the side ports of the liner.

U.S. Pat. No. 5,522,631 discloses a means for handling a submersible equipment which has a lifting bail, said means comprising a length of non-corroding, filamentary material; a hook; and means supporting said hook in suspension; where said filamentary material is in penetration of said lifting bail of said equipment and where means are provided for pulling a second end of said filamentary material, for drawing said filamentary material through said bail, and for causing said hook to snare said bail.

U.S. Pat. No. 3,853,082 discloses an apparatus for attaching a hoisting cable to a sunken vessel configured to be pulled down onto a cone-shaped line anchor. The device is pulled down onto the line anchor when the hoisting cable and a marker-buoy line are drawn in opposite directions by a pair of surface ships. This act prevents the cable and line from becoming entangled to allow connection to the sunken vessel and to reduce the hazard of inadvertently separating the more fragile marker-buoy line.

JP 62-253596 discloses a self-navigation unmanned machine for salvage of a submerged vessel. The machine uses a fitting metal ware guided by a teaser cable and a suspension cable connector.

Submersible objects, such as for instance autonomous underwater vehicles and tether controlled underwater vehicles needs to be recovered by a mother ship after a mission. The problem to be solved is to attach a load lifting agent such as e.g. a wire or a chain, to a lifting bail of such an object to be lifted. Since the object to be lifted may be residing on the sea floor or be somewhere between the surface and the sea floor. However, the most common case is when the object floating in the surface. The operation of attaching has a tendency to become a troublesome and time consuming endeavour, due to swell and heave of the sea.

One way to overcome these difficulties is to arrange some kind of guide unit between the submersed load and a lifting device, which lifting device may be arranged on a mother ship. The object to be solved then is to provide a device that is able to be guided by such a guiding unit down to the object and which automatically can attach to the object and provide a connection strong enough for lifting the object. It is an advantage if this object is solved by a device which is rugged, has few moving parts, is cost effective, and which do not need any power supply.

### SUMMARY

According to a first aspect the lifting device comprises two members connectable to each other—a first member of plate-like shape defining an opening of a particular shape, and a second member of an elongate shape having a length, and also a first cross section width and a second cross section width perpendicular to the first cross section width, where the first and second cross section widths are approximately the same at the same point along its length, and where the elongate member comprises a first end portion, a neck portion, a main body portion, and a second end portion, where said first end portion and main body portion have a width that is greater than the width of the neck portion. The opening of the first member has an elongate shape having a first portion and second portion, the first portion having a shape and a width such that the second member can be guided substantially perpendicular to the first member, in the longitudinal direction of the second member, such that the first end portion of the second member passes trough the first portion of the opening. The second portion of the opening is manufactured to have a width less than the width of the first portion and less than the width of the first end portion of the second member, but large enough to let the neck portion of the second member slide down, in substantially a sideways direction, into a far end of the second portion. In a preferred embodiment a guiding member such as a line or rope is fixedly attached to one member and slideably attached to the other, such that the members will be guided to each other as described above under the influence of gravity.

According to a second aspect the lifting device is provided with a guiding member such as a line or rope which is fixedly attached to one member and slideably attached to the other, such that the members will be guided to each other as described above under the influence of gravity.

According to a third aspect of the invention a lifting device for connecting a lifting member to an object to be lifted is provided. The device comprising a first member being connectable to the lifting member and being guidable along a guiding rope and a second member connectable to the first member and to the object to be lifted, where said first member defines a definite slot having a first portion of a first width and a second portion of a second width where said first width is greater than said second width, and where said second member is of an elongate shape, and has a head end portion of a first diameter and a body portion of a second diameter where said first diameter of the head end portion is greater than said second diameter of the body portion and also greater than said second width of the second portion of the slot of the first member but less than the first width of the first portion of the slot, the head end portion defining an orifice for the guiding rope, the second member also being provided with means for securing a rope end to it, and where the first member is provided with a rope lead for said guiding rope arranged such that when the first member is lowered towards the second member along the rope, the head end portion of the first member is guided towards, into and beyond the first portion of the slot of the first member, and when the first member is raised again for lifting, the body portion of the first member slides down in the second portion of the slot of the first member.

The lifting device where said first member is provided with stopping means for stopping the head end of the second member at a position relatively to the first portion and second portion of the slot of the first member such that the neck portion can fit into and slide down the second portion of the slot.

Said stopping means may be a plate arranged in line with the first portion of the slot of the first member and at a distance from the slot corresponding to the size of the head end portion of the second member.

According to a further aspect of the invention the lifting device may further comprise a resilient member arranged to let the second member pass into the slot at lifting, and to prevent said second member from sliding back and leaving the slot in the event of lifting tension relieved.

According to still a further aspect the first member may be of L-shape.

According to further aspects of the invention, members are provided separately, i.e., provides is a first member suitable of being part of a lifting device, said first member (101) defining an opening, where the opening has an elongate shape having a first portion and second portion, the first portion having a first width and where the second portion of the opening has a second width which is less than the first width. The first member (101) may also be provided with stopping means for stopping a head end of an elongate object that moves into the first portion of the opening. The first member may also be provided with guiding means for a rope, said guiding means being arranged to guide the rope through the first portion of the opening.

A second member suitable of being part of a lifting device is also provided, said second member having an elongate shape with a head end portion and a neck portion, where a width of the head end portion is greater than a width of the neck portion, and where said second member is provided with an orifice at the head end portion, suitable for a rope. The second member may also be provided with a rope direction change element for changing the direction of the rope. The rope direction change element may be a pulley or a polished pin or similar.

According to a final aspect is provided an unmanned underwater vehicle lifting-device according to the above paragraphs.

### BRIEF DESCRIPTION OF THE DRAWINGS

FIGS. 1a and 1b are views of a first member of a lifting device from two different angles of viewpoint.

FIG. 1c is a view of the first member of a connection device further provided with a rope guiding structure for guiding along a rope and a spring element.

FIG. 2a is a view of a second member of a connection device.

FIG. 2b is a cross-sectional view of the second member of FIG. 2a

FIG. 3a-3f are views showing certain positions when using the device of FIGS. 1a, 1b and 2a and 2b for connecting an object for lifting.

FIGS. 4a and 4b shows a lifting device where the first member is arranged to be connected to an object to be lifted and a second member is arranged to be slideable along a guiding rope, i.e., inversely compared to the device of FIG. 3a-3f.

FIG. 5 is a cross-sectional view of an embodiment using a double rope to guide a first member and a second member towards each other.

### DETAILED DESCRIPTION OF PREFERRED EMBODIMENTS

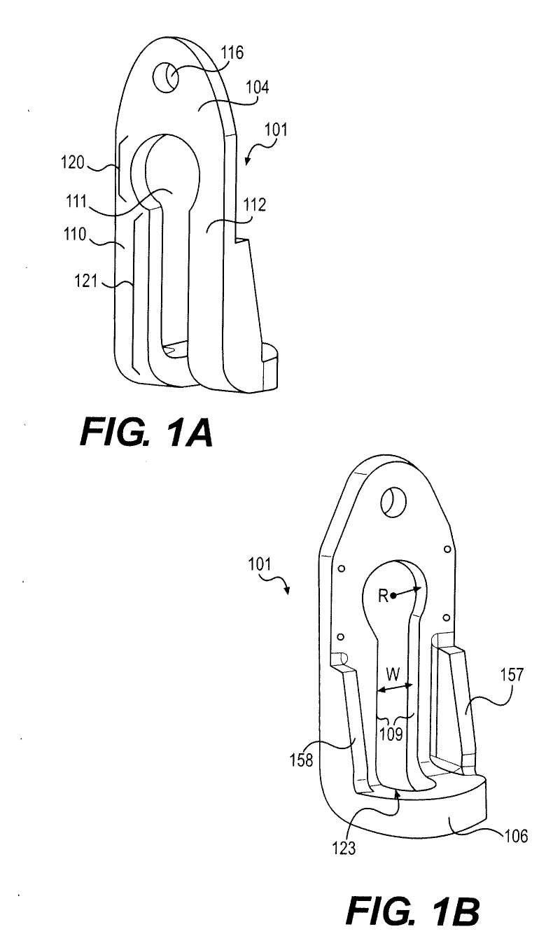

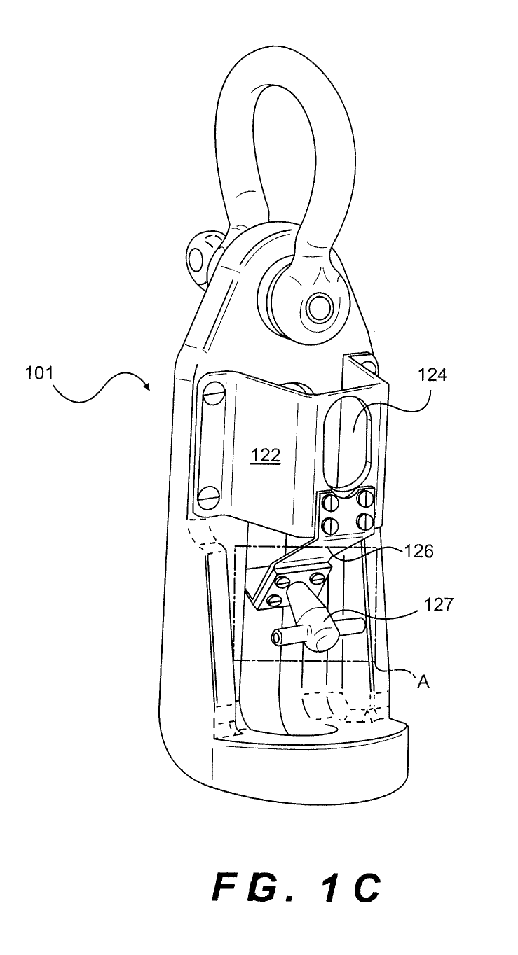

FIG. 1a shows a first member 101 of a lifting device. FIG. 1b shows the same from a different angle. The first member 101 comprises an upper yoke portion 104 connected integral to two substantially parallel elongate member portions 110, 112 which in turn are connected by a lower yoke portion 106 such that said portions 104,106,110, 112 defines an elongate opening between them. The opening has an upper and a lower end, and an upper end portion 120 defined by an edge line. The edge line is preferably part of a circle with a radius R, or at least of a shape letting an object having a certain cross section shape and size pass. The edge line is preferably such that a head portion of a second member as described below, can pass. This upper end portion 120 of the opening will from now on be referred to as the “receiving portion” 120 of the opening in the first member 101. A middle, elongate portion of the opening has substantially parallel sides 109 defining a width W between them. A lower portion of the opening is preferably semicircular to smoothly terminate the opening at a lower end. The first member 101 is preferably manufactured of a piece of plate metal of L-shape, such that the lower yoke portion corresponds to the lower portion of the “L”. The advantage of this will become apparent later.

In an alternative embodiment the lower yoke is replaced with a blocking structure arranged to stop a member from sliding out of the elongate opening. In still another embodiment the upper yoke is arranged to be able to open, or there may be arranged a passage in the first member 101 into the elongate opening such that a rope or similar may be entered into the elongate opening, without needing to take an end of the rope and thread it through the elongate opening.

FIG. 1c shows the first member 101 of FIGS. 1a and 1b, comprising also a rope guiding structure 122. The rope guiding structure 122 may be manufactured of a piece of sheet metal bent to an U-shape and attached to the upper yoke portion 104 and/or elongate portions 110,112 of the first member 101 such that a hole 124 centrally arranged in the piece of sheet metal 122 is positioned in line with the receiving portion 120 of the opening of the first member 101. A spring element 126 is preferably attached to the first member, preferably to the guiding structure for locking the second member in a lifting position which will be further explained below. An opening handle 127 may be arranged on the spring member for easy gripping and withdrawing of the spring member for manually releasing the first and second member from each other after lifting operation is completed.

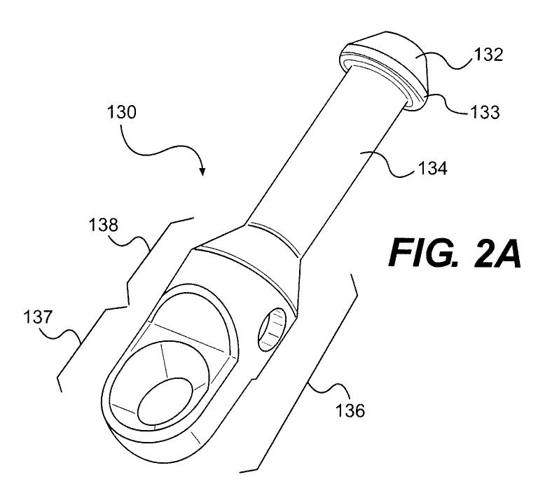

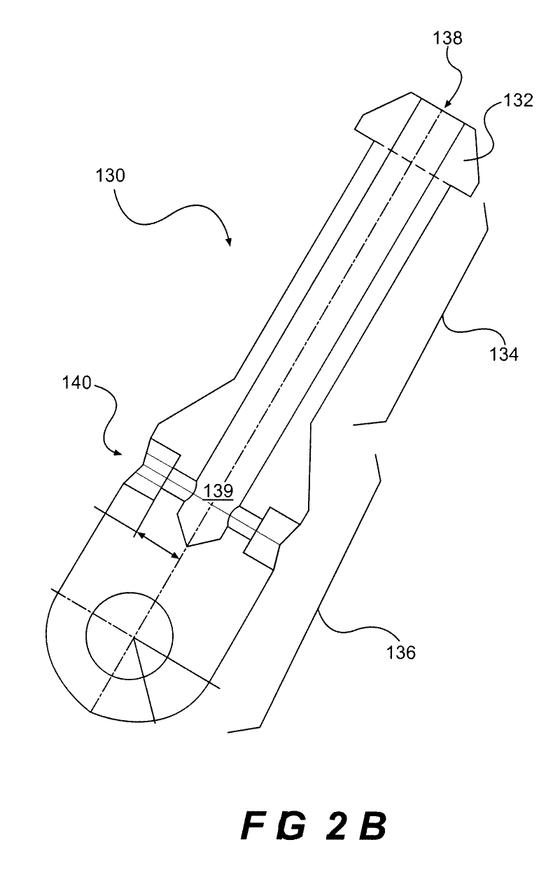

FIG. 2a shows a second member 130 of the lifting device, said second member 130 being of elongate shape, having a length and a first end 132 with a head portion 132 being devised to be insert able into the upper end of the opening of the first member 101, said head end being integral with a neck portion 134, the neck portion further being integral with a main portion 136. The head end portion preferably being of conical shape. The main portion 136 comprises at a second end 137 a ring or similar for attaching the second member 130 to the object to be lifted, e.g., by means of a shackle or the like. The second member 130 is preferably of circular profile, to avoid any necessary rotation along a longitudinal axis when being inserted into the upper end of opening 111 of first member. Such rotation would almost certainly be necessary if the profile was oval, square, rectangular or triangular, and the opening of a shape to match it. However, other profiles are possible. In an alternate embodiment the profile envelope is circular but may be provided with groove or other indentations for reduced friction.

Now referring to FIG. 2b, which is a cross sectional view of the member of FIG. 2a, the second member 130 also comprises securing means for a guidance filament, for instance a line or a rope, and guidance means for presenting said guidance filament at a favourable position for guiding the head portion 132 of the second member 130 and the receiving portion 120 of the elongate opening of the first member towards each other during an attempt to attach the two to each other. Said securing and guidance means comprises an axial bore 138 extending through the head portion 132 and the neck portion 134 to the main portion 136. A main portion end 139 of said bore 138 connects to a substantially perpendicular bore 140 for a pin (not shown in FIG. 2b) for anchoring a rope to the second member 130 by being positioned in a sling of said rope (not shown).

When recovering an unmanned vehicle with the aid of a lifting device according to the invention, it is important to avail oneself of a guide rope or line. Said rope is provided with an object or vehicle end that ends in the second member 130, and said second member 130 is attached to the unmanned vehicle by means of a shackle or the like. The rope may initially be releasable strapped to a tether cable of the unmanned vehicle. The guide rope may preferably have a length of approximately 20 m. The rope may alternatively be freely floating, in which case it is an advantage if the rope is manufactured of a floating material. In this case it is devised that the rope be recovered by personnel from the mother ship. In a further embodiment the rope may be stowed in or at place or similar at the submersible and may be collected e.g., with the aid of a boat hook. In such a case the rope may also be provided with a buoy releasable from the submersible. In still another alternative the rope may be provided by attaching by hand. In still a further alternative embodiment the tether cable is used a guide rope, and means are provided for arranging the tether cable to pass through the elongate opening of the first member. The means may comprise a yoke that can be opened and closed. Or a passage in the material defining the elongate opening.

For the purpose of explaining the invention it is assumed that the personnel onboard a mother ship has got their hands on the free end of the rope and are able to thread the rope through the opening of the first member 101 and through the guiding hole 124 of the guiding structure 122, in that order. The free end is then attached to a suitable structure capable of creating some tension in the rope. In an alternative embodiment, and as explained above, the first member is provided with means for putting the rope into the opening without having to thread its free end through it, e.g. by having a yoke that can be opened and closed or a fixed passage into the elongate opening.

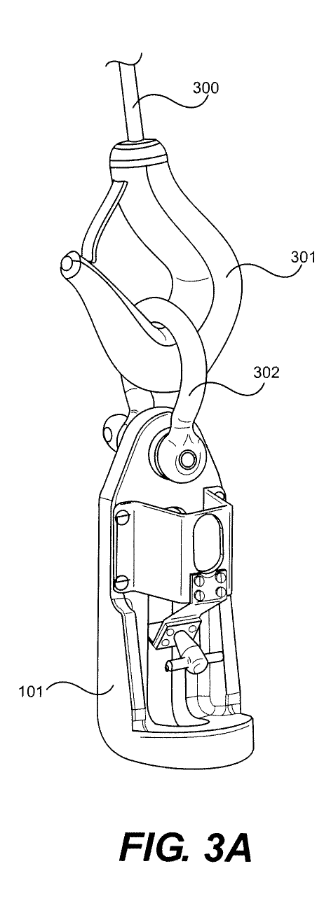

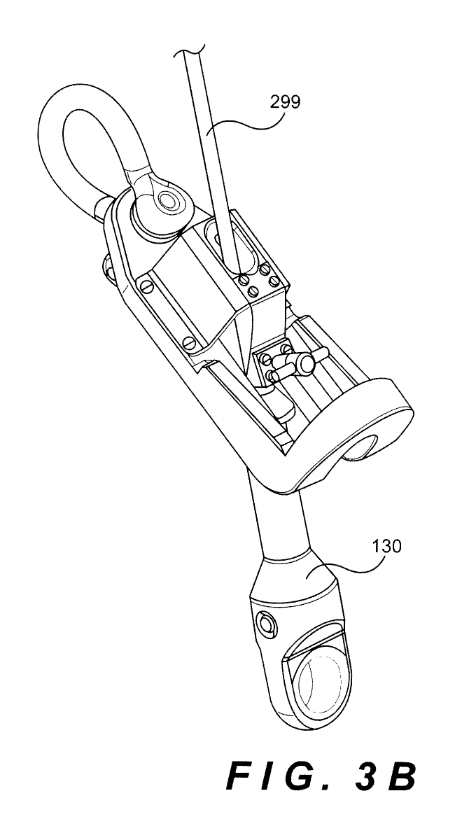

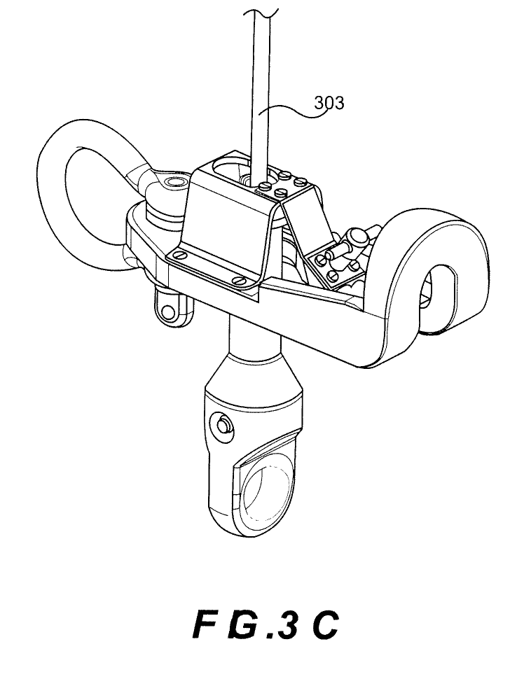

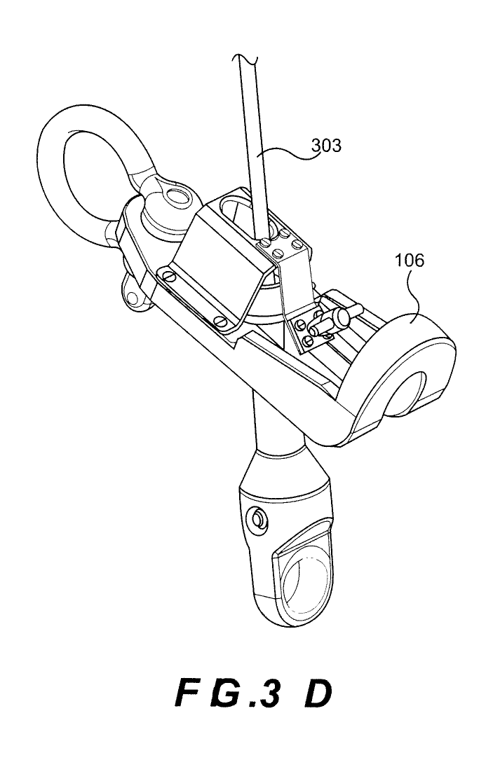

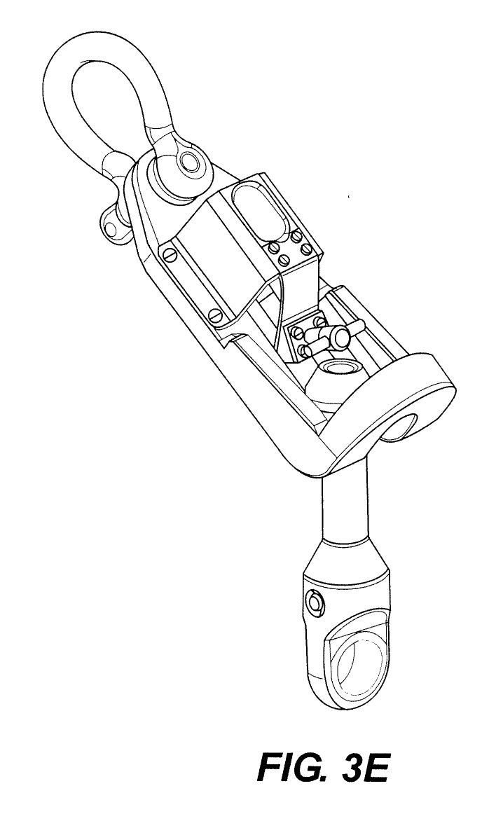

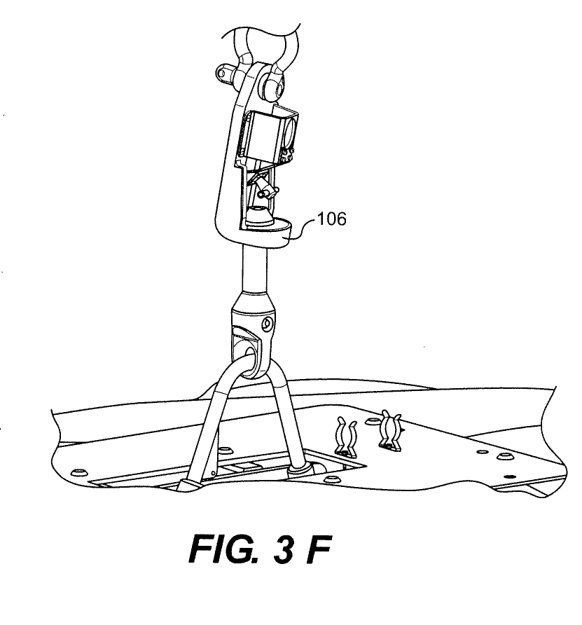

A method for using the attachment device comprising a first member 101 and a second member 130 will now be described with the aid of FIGS. 3a to 3f. FIG. 3a shows the first member 101 attached to a lifting hook 310 by means of a shackle 302. The rope is not shown for clarity. As can be seen in FIG. 3b, as a first step, the rope is tightened such that the second member 130 assumes a position such that the first member 101 can be guided into a position over the second member 130. This is achieved in an upright position, but also other positions. Subsequently the first member 101 is lowered towards the second member 130. When the first member is lowered and approaches the second member, the head end 132 of the second member 130 slides into the receiving portion 120 of the opening of the first member 101, see FIG. 3c. Next, the lifting is started.

With reference to FIG. 3d, the head end 132 of the second member slides on the “inside” of the attachment device down towards a spring element 126. The spring element may be a bent sheet of metal. This spring element 126 is arranged to guide the rope when the first member is lowered. It is also devised to work as a locking device when the first and second member have connected into each other and are ready for lifting, for preventing accidental un-connecting if a slack would appear when lifting. The rope is secured in the second member by means of a pin. This pin may be of a material having a comparatively low strength, such as e.g., plastic, such that the pin can function as a breakpin in a case the rope gets stuck when the vehicle is on its way. In alternative embodiments the rope can be secured to the second member in other ways, as is known to a person skilled in the art. In still another embodiments the rope extend through the second member and is secured to the object to be lifted.

FIG. 3e shows a position where the head portion of the second member has passed the spring member and is unable to slide out of the first member, without anyone actively removes it. The rope is not shown.

When the first member is gradually lifted, the second member gradually slides down to an end position, and everything is set to lift the vehicle out of the water, see FIG. 3f. Rope is not shown. From the figure is also seen that the first and second member assume an aligned position in the direction of lift, due to the L-shape of the first member since the second member slides down to the bottom of the “L” where a flange structure 133 of the head portion 132 of the second member 130 contacts an transfers lifting forces to the lower yoke portion 106, which in this case constitutes the bottom of the “L”, and to a certain degree to the elongate member portions 110, 112. The lower yoke portion 106 may be semicircular or U-shaped to allow for such advantageous distribution of forces, or at least provide a glide path for the second member to become aligned with the first member.

In an alternative embodiment the second member is embodied as an integral portion of the guiding rope provided with an enlargement at a distance from the rope end. In such an embodiment said portion of the guiding rope is preferable reinforced appropriately to be strong enough to manage the load of the object to be lifted. The enlargement may be a knot.

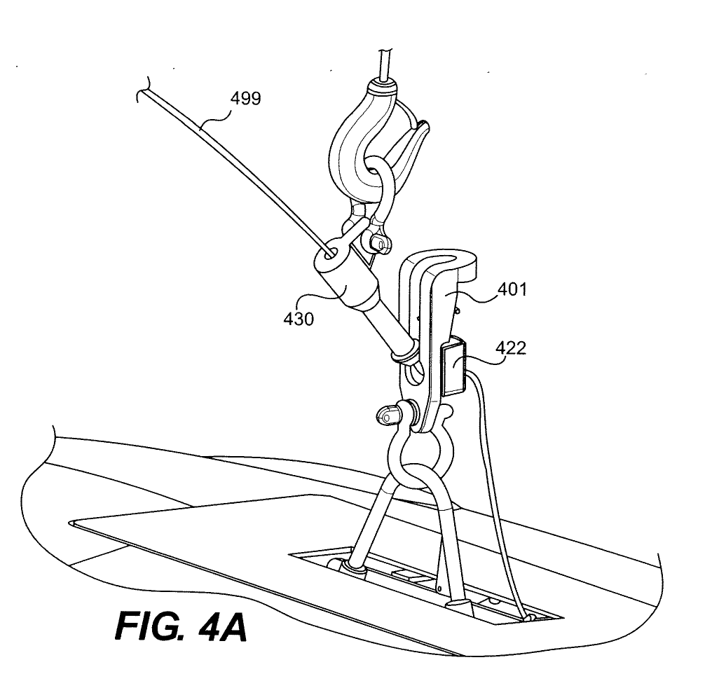

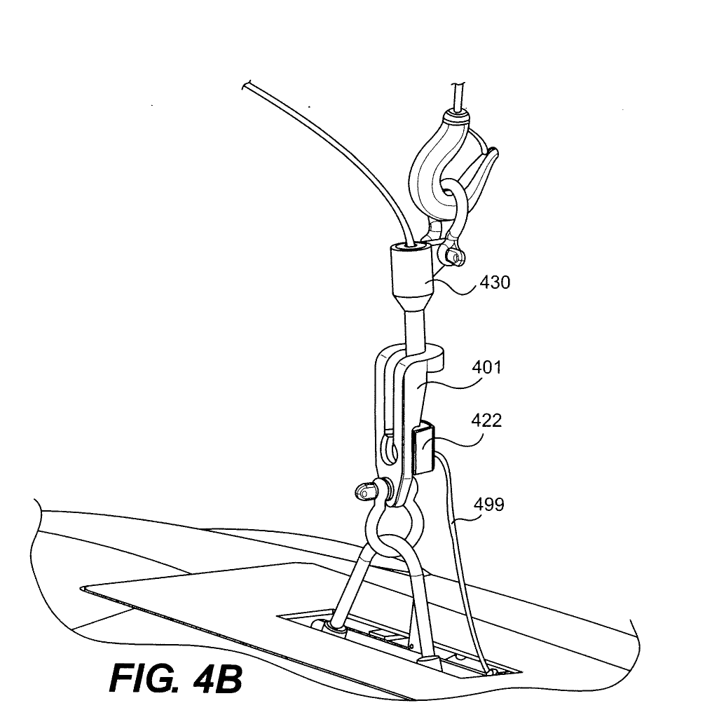

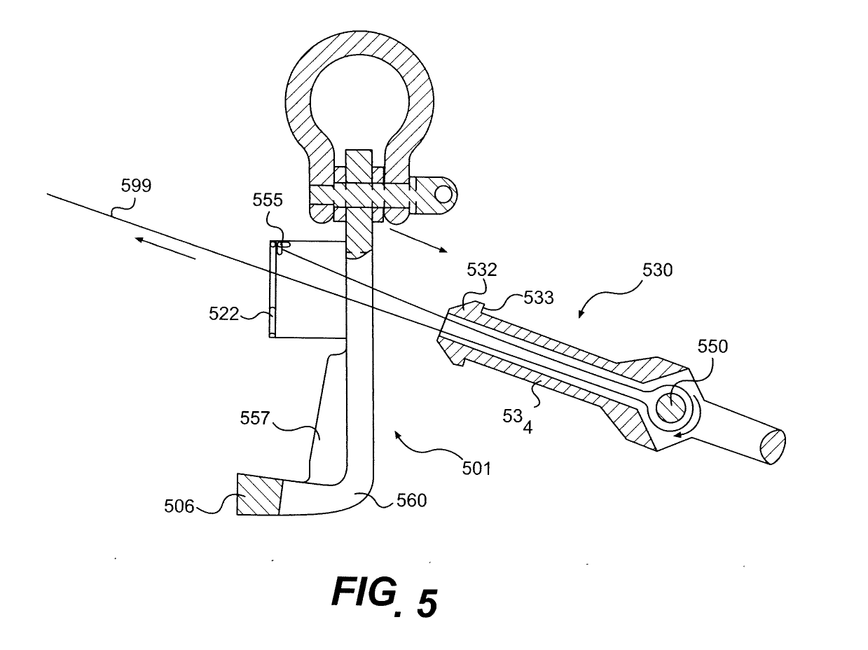

FIGS. 4a and 4b shows a lifting device where a first member 401 is arranged to be connected to an object to be lifted and a second member 430 is arranged to be slideable along a guiding rope 499, i.e., inversely compared to the device of FIG. 3a-3f. The second member 430 is provided with guiding means for the rope 499, in this embodiment these guiding means comprise an axial bore throughout the entire length of the first member 430. The first member 401 is provided with rope guiding means 422 for guiding the rope such that when the second member 430 slides along the rope under the influence of gravity, the second member 430 will slide into the opening 111 of the first member 401, in analogy to what is described in detail above.

FIG. 5 is a cross-sectional view of an embodiment using a double rope to guide a first member and a second member towards each other. A first member 501 is provided with an attachment point 555 for a rope 599. A second member 530 is provided, in analogy to what is described in FIG. 2a, with a head portion 532, a neck portion 534, and an axial bore running through said neck portion and forming an orifice at a farther end of the head portion 532, for the rope 599. A rope direction change element 550, for example a pulley or a polished pin is arranged in line with the axial bore, to change direction the rope, such that when the rope 599 is pulled the first member 501 and second member 530 are brought closer to each other, and when pulling is continued they will eventually connect. Said attachment point 555 for the rope 599 is arranged at a position on a portion of the first member 501 such that the head portion 532 of the second member will enter the opening 111 of the first member 501.

From FIGS. 5 and 1b it can also be seen that the first member 101, 501 preferably is provided with one, or preferably two reinforcement portions 157, 158, 557, for reinforcing the first member at an angle 560, where elongate member portions 110, 112 transforms into lower yoke portion 106, 506.

It should be understood that the term “rope” in the context of the present application should be interpreted as a long flexible member equivalent to a line, a rope, a wire, a thin chain or similar.

1. A lifting device, comprising:
a first member and a second member connectable to each other, the first member defining an opening, the second member having an elongate shape having a length and a cross section profile changing size along the length, wherein the second member comprises a first end portion, a neck portion, a main body portion, and a second end portion, where said first end portion has a width that is greater than a width of the neck portion, wherein the opening of the first member has an elongate shape having a first portion and second portion, the first portion having a shape and a width such that the second member can be guided to the first member, or vice versa, such that the first end portion of the second member can pass trough the first portion of the opening, and wherein the second portion of the opening has a width less than the width of the first portion of the opening and less than the width of the first end portion of the second member, but large enough to let the neck portion of the second member slide down into a far end of the second portion.

2. The lifting device according to claim 1, further comprising
a guiding member non-moveably attached to one of the first member and the second member and slideably attached to another of the first member and the second member, such that the first member and the second member can be guided to each other with the aid of the rope.

3. A lifting device, comprising:
a lifting member to be connected to an object to be lifted,
a first member being connectable to the lifting member, said first member defining a definite slot having a first portion having a first width and a second portion having a second width, wherein said first width is greater than said second width,
a guiding rope and configured to guide the first member, and
a second member connectable to the first member and to the object to be lifted, wherein said second member has an elongate shape, and has a head end portion having a first diameter and a neck portion having a second diameter wherein said first diameter of the head end portion is greater than said second diameter of the neck portion and also greater than said second width of the second portion of the slot of the first member but less than the first width of the first portion of the slot, the head end portion defining an orifice for the guiding rope, the second member further comprising means for securing a rope end to it, and wherein the first member comprises a rope lead for said guiding rope arranged such that when the first member is lowered towards the second member, or vice versa, along the rope, the head end portion of the second member is guided towards, into and beyond the first portion of the slot of the first member, and when the device is raised again for lifting, the neck portion of the first member slides down in the second portion of the slot of the first member.

4. The device according to claim 1, wherein said first member is a stop configured to stop the head end of the second member at a position relatively to the first portion and second portion of the elongate opening of the first member such that the neck portion can fit into and slide down the second portion of the elongate opening.

5. The device according to claim 4, wherein said stop a plate arranged in line with the first portion of the slot of the first member and at a distance from the slot corresponding to the size of the head end portion of the second member.

6. The device according to claim 1, further comprising:
a resilient member arranged to let the second member pass into the slot at lifting, and to prevent said second member from sliding back and leaving the slot in the event of lifting tension relieved.

7. The device according to claim 1, wherein said first member has an L-shape.

8. A first member suitable of being part of a lifting device, said first member comprising:
an opening having an elongate shape having a first portion and second portion, the first portion having a first width and where the second portion of the opening has a second width which is less than the first width.

9. The first member according to claim 8, wherein said first member is provided with stopping means for stopping a head end of an elongate object that moves into the first portion of the opening.

10. The first member according to claim 9, further comprising:
a guide configured to guide a rope through the first portion of the opening.

11. A second member suitable of being part of a lifting device, said second member comprising:
an elongate shape with a head end portion and a neck portion, where a width of the head end portion is greater than a width of the neck portion, and where said second member is provided with an orifice at the head end portion, suitable for a rope.

12. The second member according to claim 11, where said second member further comprising:
a rope direction change element.

13. The second member according to claim 12, wherein said rope direction change element comprises a pulley or a polished pin.

14. An unmanned underwater vehicle lifting-device, comprising:
a lifting device according claim 1.

15. The lifting device according to claim 2, wherein the guiding member comprises a rope.
